(19) United States
(12) Patent Application Publication
(10) Pub. No.: US 2021/0264750 A1
(43) Pub. Date: Aug. 26, 2021

(54) System and Device for Covert Tactile Communication in Team Activities to Gain a Strategic Advantage Over an Opponent

(71) Applicant: William Gerard Leary, Natick, MA (US)

(72) Inventor: William Gerard Leary, Natick, MA (US)

(21) Appl. No.: 17/180,756

(22) Filed: Feb. 20, 2021

Related U.S. Application Data
(60) Provisional application No. 62/978,904, filed on Feb. 20, 2020.

(51) Int. Cl. G08B 6/00; H04B 1/3827

(52) U.S. Cl. CPC G08B 6/00; H04B 2001/3861; H04B 1/385

(57) ABSTRACT

A multiple user covert and tactile wireless communication system used to gain a strategic advantage over an opponent in a team activity. Users are equipped with tactile communication transceivers embedded within an article of clothing that may take the form of a glove, custom article, or sport or activity-related article worn by a user. Each tactile communication transceiver is equipped with pulse triggering devices for transmitting messages to other users by the fingers of the hand and vibration producing devices for receiving messages from other users by tactile stimulation of the fingers of the hand. By virtue of its design the tactile communication transceiver positions each finger of the hand adjacent to a designated pulse triggering device and designated vibration producing device. Each digit of the hand represents a specific symbol of a language known only to the users of the covert tactile communication system.

### CROSS-REFERENCE TO RELATED APPLICATIONS

This application claims the benefit of provisional patent application No. 62/978,904 filed 2020 Feb. 20 by the present inventor.

### STATEMENT REGARDING FEDERALLY SPONSORED RESEARCH OR DEVELOPMENT (IF APPLICABLE)

Not Applicable

### REFERENCE TO SEQUENCE LISTING, A TABLE, OR A COMPUTER PROGRAM LISTING COMPACT DISC APPENDIX (IF APPLICABLE)

Not Applicable

### BACKGROUND OF THE INVENTION

The present disclosure relates generally to devices, systems, and methods for communicating wirelessly to another user or users through vibrotactile signaling. More specifically, the present disclosure utilizes the fingers of the hand to send and receive covert messages over a secure wireless network in a silent and undetectable manner. The present disclosure provides a solution to the problem of intercepted or decoded hand signals or other non-verbal cues that are used to gain a competitive advantage in sports and other activities. Once these hand signals or other non-verbal cues are decoded, the competitive advantage is lost.

Numerous technologies utilizing vibrotactile signaling, some utilizing the fingers of the hand, are available for communicating non-verbal cues. They fall short against the present disclosure in that they do not maintain covert communications and/or their implementation is impractical and would adversely impact the associated game or other relevant activity. The following is a tabulation of some prior art that presently appears relevant.

### U.S. Patents

| Pat. No. | Issue Date | Patentee |
|---|---|---|
| 9,858,773 | 2018 Jan. 2 | Deschamps |
| 9,953,494 | 2018 Apr. 24 | Rothschild |
| US 2013/0162398 | 2013 Jun. 27 | Stoick |
| 8,093,997 | 2012 Jan. 10 | White |
| 7,696,860 | 2010 Apr. 13 | Gilson |
| 7,271,707 | 2007 Sep. 18 | Gonzales |
| 7,164,348 | 2007 Jan. 16 | Smith |
| 7,098,776 | 2006 Aug. 29 | Chang |
| 7,046,151 | 2006 May 16 | Dundon |
| 7,012,593 | 2006 Mar. 14 | Yoon |
| 6,930,590 | 2005 Aug. 16 | Ling |
| 6,326,901 | 2001 Dec. 04 | Gonzales |
| 6,230,135 | 2001 May 8 | Ramsay |
| 6,141,643 | 2000 Oct. 31 | Harmon |
| 5,719,561 | 1998 Feb. 17 | Gonzales |
| 4,905,001 | 1990 Feb. 27 | Penner |

### Non-Patent Literature Documents

Axisa, Mike, CBS Sports.com, “MLB exploring ways to use on-field technology to help prevent sign-stealing, report says” (Jan. 6, 2020)
Altman, Evan, CubsInsider.com, “K-Band Wearable Tech Could Solve MLB's Sign-Stealing, Pace-of-Play Issues”

Major League Baseball (MLB) is in need of a solution to pitch sign stealing and will benefit from the current disclosure. A pitcher's effectiveness against an opposing batter is based on the element of surprise, which is lost once the batter has knowledge of the upcoming pitch type. A catcher must initiate a predetermined sequence of finger movements to communicate a desired pitch (e.g. one finger for a fastball or 2 fingers for a curveball), all the while attempting to keep the exchange out of the field of view of the batter and baserunners. Pitch sign sequences are sometimes modified if there is a baserunner on second base (who has a view of the catcher's signs) or if there is a sense that the opposing team has “decoded” the pitcher-catcher communications. This need to revise the sign sequences causes delays in the action and possible miscues if the new signs are not interpreted correctly.

While sign stealing has always been part of the game and is legal if no electronic devices (such as video cameras) are used by the teams to decode signs, it has reached a new level of urgency with the recent Houston Astros and Boston Red Sox cheating scandals. Both teams have been implicated in the illegal use of electronic devices (Apple Watches) or video cameras to steal signs, resulting in managerial firings, fines, and damage to the brand and integrity of MLB. A second concern of MLB is the increase in the average length of a game as a result of the constant need to change sign signals to keep the opposition off balance. Longer game times are driving fans away from baseball.

### Testing of Prior Art Prototype Systems

As cited in the two referenced non-patent literature documents, prototype solutions to avoid sign stealing were tested in recent years by MLB and are expected to continue. The first to be considered was wireless voice communications between the pitcher and catcher. The feedback from pitchers was that the earpieces were uncomfortable and were prone to falling out of the ear during the course of play. One other concern is the possibility of an opposing player overhearing the catcher-pitcher conversation or determining the pitch type through lipreading.

A device called the K-Band, developed by the K-Band company, was introduced to college and minor league baseball for possible testing in 2019. It is worn on the wrist of the gloved hand of the pitcher, catcher, position players, and coaches, and has a screen on the inside of the wrist for discreet selection and viewing of the pitch type. The catcher or manager enters the pitch type and location which is received by the pitcher and position players. While a possible solution to the sign stealing issue, it does nothing to improve the speed of the game as it requires the catcher to divert attention from the game to the device if the pitcher shakes off a sign, requiring a second pitch type to be called.

Pitch selection can be very dynamic, requiring last minute changes in a call due to such things as a runner on base threatening to steal. Using this as an example, the catcher might call a pitchout at the last second. Having to enter a call into the K-Band provides the competition with a visual clue that a pitchout is coming and an opportunity to wait for a better opportunity to steal the base. Conversely, a baserunner on the opposing team could take advantage of the catcher diverting attention to the device and get a good jump on stealing a base. The element of surprise is lost.

In today's game, the coaching staff will periodically relay changes in game tactics from the dugout with hand signals. Also, infielders will adjust their positioning based on knowledge of the called sign by the catcher (they can see the number of fingers shown by the catcher). The K-Band system has the capability for the coaching staff to provide input, and all players are outfitted with the device and can see the pitch call. The shortcoming for K-Band is (again) the need to divert attention from the game to read the coaches instruction or in the fielder's case to view the pitch type, possibly allowing the opposing team to get a good jump on a stolen base.

MLB tested a system during spring training 2020 that consisted of a control panel installed in the dirt adjacent to the catcher for entering the pitch call. The control panel was connected to a panel of lights installed in front of the pitcher's mound that displayed the catcher's pitch call. This is a one-way communication device (only the catcher can enter a pitch type), does not allow coaching staff input, and infielders may not be aware of the pitch call if the lights are not in their field of view. In addition, it would become a permanent installation in all ballparks, adding installation and maintenance costs. Like the K-Band, it will not improve the speed of the game.

Another device under consideration by MLB is a wearable random number generator in possession of the pitcher and catcher. It produces a value corresponding to the order in a pitch sequence (say the third sign) that is to be thrown. Imagine that the catcher flashes a series of hand signals (using the traditional method) to the pitcher, making sure that the desired pitch type is the third sign flashed. The pitcher, with knowledge of the same random number, would throw the third pitch type in the sequence. As with the K-Band and lights in the mound methodologies, the random number generator slows the pace of play. If the pitcher shakes off the sign a new number needs to generated and the process repeated. Last second changes (such as a pitchout in the example above) are not possible, infielders are not aware of the pitch call, and the coaching staff does not have input to the calls.

The present disclosure overcomes all the limitations of the prior art with covert two-way sign calling, capability to signal last second changes without giving any clues to the opposition, coaching staff input is provided, position players have knowledge of the selected pitch, no changes to field or stadium infrastructure is necessary, and the pace of play is increased.

While various means of tactile signaling exist in the prior art, none meet all the requirements of the current disclosure which include silent, covert, multi-finger communication between two or more people. Additionally, the system must integrate into clothing or equipment used by the sport or other relevant activity without causing discomfort or impeding performance.

### Review of Prior Art for Two-Way Tactile Signaling

The prior art for tactile signaling systems include pulsating radio devices such as pagers and notification systems. Furthermore, systems are employed to enhance communication via tactile stimulation, and provide alternatives to a keyboard through hand-held devices. Other tactile signaling systems include glove type data input devices, and wirelessly connected body suits that provide users with interactive tactile stimulation capabilities. A review of prior art patents that appear relevant follows below.

U.S. Pat. No. 8,093,997, issued to White, is a two-person silent communication system whereby pulses are communicated back and forth by the movement of the index finger against a pulse triggering mechanism in a sending unit. A corresponding vibratory pulse from a receiving unit is received by the other user. Each user is equipped with a sending unit consisting of a glove with a single pulse triggering mechanism and transmitting radio, and a receiving unit in the form of a patch worn on the body that includes a receiving radio and a vibratory element which imparts a tactile vibration in response to a pulse from the first user.

As White describes, “a system such as Morse code may be used by the first user to tap out a message such that the second user received and interprets a coded message by the series of long or short tactile sensations”. The White system does not meet the need for covert communications in that the action of “curling” the index finger to activate the transmitted signal can be seen by others in the vicinity of the communicator. The number of “finger taps” may be counted by an observer, and the message decoded. The White system only offers a single finger-activated pulse, which limits the communicated “language” to simple ones such as Morse Code, and is limited to only two users. The White system does not meet the requirement for an integrated solution (i.e., packaged within a single glove or article of clothing) thus resulting in discomfort to a user or an impediment to the performance of participants in a relevant sport activity. Of particular concern is the remote location of the receiver in relation to the transmitter, with wires running between the transmitter on the user's hand and the receiver patch positioned on the arm or torso. The need for two radios and supporting electrical circuitry and power supply (with separate transmitter and receiver), in addition to not integrating into the “uniform” of the user, increases the system cost and maintenance requirements.

Another two-person silent communication system is presented in U.S. Pat. No. 7,696,860 issued to Gilson. It discloses a system that communicates tactile data to and from a user and monitors the user's health. The preferred embodiment is for a soldier in a battle situation who is outfitted with a wireless touch communication device in the form of a belt that includes an array of electromechanical transducers each independently capable of producing a vibration for communicating qualitative and quantitative tactile cues.

A remote leader with a hand controller can send cues (such as halt or move out) and receive data relevant to the soldier's health. The hand controller may be replaced with a computer or other static monitoring device. Both can send cues based on a perceived threat to the soldier (such as the location of gunfire) and receive health data. As an example, when a command is sent to the soldier (e.g. move right) the electromechanical transducer positioned on the right side of the torso will buzz.

As the soldier moves or breathes, the action applies compression to the electromechanical transducers and induces an electromagnetic (EMF) force which is converted into health-related signals sent back to the controller or computer. By monitoring the output signal of the electromechanical transducers, a remote leader, whether monitoring the hand controller or computer, can determine if a soldier is under duress, incapacitated, or deceased. The user can send a message back to the controller or computer by actuating the electromechanical transducers.

While the Gilson invention discloses a silent method for 2-way tactile signaling, its physical configuration (waist band with electromechanical transducers positioned against the torso) does not meet the need for an integrated solution into clothing or equipment used by a sport or other activity. It does not provide the capability to communicate “belt to belt”, instead each user communicates with a manned controller or stationary computer. While the Gilson invention discloses that the waist belt may be worn on any part of the body, including the hand, it loses the benefit of stealth by virtue of its design. The user must interact with the electromechanical transducers positioned around the circumference of the belt to initiate or return a message. The act of the user depressing an electromechanical transducer may be visually detected by others in the area.

### Review of Prior Art for One-Way Tactile Signaling

An example of a one-way tactile signaling system is presented in U.S. Pat. No. 7,164,348 issued to Smith which discloses an inconspicuous tactile notification for speaking engagements. Its function is to alert a presenter via a vibrotactile cue from a moderator of a message. The cue could include an alert to a time limit, or a Morse code message related to the presentation content. The vibratory unit may be attached to a microphone (sending a cue to the hand) or worn by the presenter.

Other approaches to one-way tactile signaling are found in U.S. Pat. Nos. 5,719,561, 6,326,901, and 7,271,707 each issued to Gonzales. They disclose tactile communication devices for use in tactile communications adaptable for use by anyone able to recognize messages written in a language known to them. Sequentially fired vibromechanical stimulators, arranged in a two-dimensional array, are positioned against the skin of the user. The stimulators are triggered individually and in sequence to tactually convey a set of patterns representative of the symbols in a language that are recognizable to the wearer. The wearer cognitively perceives the tactual stimulation as a line or lines drawn on the skin or suitably tactile sensitive area that resemble the symbols used to communicate between the message sender and the wearer.

Another one-way tactile signaling system is presented in U.S. Pat. No. 6,230,135 issued to Ramsay et al. which discloses a tactile communication apparatus and method. The invention uses speech recognition software and refreshable braille devices to convey spoken communications directly to the user in a tactile form of communication. The apparatus of the invention includes several embodiments of portable tactile communication devices. These devices include a computer controller which receives communications as electrical signals and converts the electrical signals to the Phonetic Braille Code.

The controller activates one or more refreshable braille displays to communicate these translated signals tactilely to the user. In one embodiment, a portable transmitter translates the spoken word into a signal which is then sent to a portable receiver and tactile communicator. The receiver then presents a corresponding braille display so that the user can receive the communications in a tactile form. In a second embodiment, a receiver consisting of a finger- and wrist mounted unit is employed. Finger sleeves (tubular sleeves of an appropriate size for fitting over the user's fingers) contain a refreshable braille display pad in contact with the user's fingers so that the user is able to tactilely sense braille symbols.

Review of Prior Art for Tactile Signaling from Mobile Devices

A system for communicating messages from a mobile device to a user through tactile stimulation is presented in U.S. Pat. No. 9,858,773 issued to Deschamps. It discloses a wearable computer having a skin-stimulating interface. Techniques that provide electrical stimuli to the skin of a user in response to a notification signal from a mobile device are described. For instance, the electrical stimuli may inform the user of an event, a condition, etc. Examples of an event include but are not limited to receipt of a message (e.g., an email, an instant message (IM), a short message service (SMS) message, or a transcribed voicemail), receipt of an alarm (e.g., an alarm clock alarm or a warning), receipt of a phone call, occurrence of a time of day, etc. The electrical stimuli may inform the user of a condition of clothing that is worn by the user, or that a physical positioning of the user is to be changed.

A second device for communicating messages from a mobile device to a user through tactile stimulation is found in U.S. Pat. No. 9,953,494 issued to Rothschild. It discloses a device, system and method for mobile devices to communicate through skin response. Messages are received over a network by a mobile device which wirelessly transmits the message to a vibrotactile device configured to be worn on the skin of a user either as an arm patch or wristwatch. Single or multiple transducers communicate through vibration against the skin simple Morse Code type messages or with a matrix of transducers can spell out letters of a message. This system is useful to the hearing or visually impaired or for users who do not want to hear or see messages that are being communicated to them through a mobile device. Both the Microsoft Technology Licensing LLC and Rothschild are limited to one-way communication via the vibrotactile transducers. A responding message is sent through the traditional means offered by the mobile device.

U.S. Pat. No. 7,098,776 issued to Chang et al. discloses methods and apparatus for vibrotactile communication. It relates to verbal speech enhancement of voice communications over a cellphone via tactile cues. While the fingers of the hand are used to send cues, they are in plain view of an observer. The device integrates into a cellphone (such as Motorola's iDEN i730 multi-communication device) and provides fingertip pressure sensors for sending a signal and vibratory actuators for receiving a signal. With the hand in position on the phone, each finger has a corresponding pressure sensors and vibratory actuators. Tactile gestures from the finger or fingers of the transmitting user are received as vibratory pulses at the same finger or fingers of the receiving user.

### Review of Prior Art for Enhancement of Activity Through Tactile Signaling

Tactile stimulation is also used to enhance an activity or interaction with another user. One such system is found in U.S. Pat. No. 6,930,590 issued to Ling et al. which discloses a modular electrotactile system and method for delivering tactile stimuli to a skin surface of a user. The system is used in virtual reality, telepresence, telerrobotics, or other haptic feedback applications. It utilizes arrays of electrodes electrically connected to an integrated circuit that are positioned against the skin within an article of clothing worn by the user. The electrodes emit a low current to the skin of the user in response to a system output. These outputs simulate a physical sensation as related to the systems previously described. Inputs to the system may be received from the user through a handheld device or other devices related to the application. The system is capable of receiving and transmitting tactile data via a communication link, such as a conventional data network.

Another example of tactile stimulation being used to enhance an activity or interaction with another user is found in U.S. Pat. No. 7,046,151 issued to Dundon. It discloses an interactive body suit and interactive limb covers. Users interact over the Internet or wireless communications network with games or each other, whereby the sensation of touch is felt by the garment user. Peripheral gloves, socks, and adult entertainment devices for men and women attach to the interactive body suit in appropriate locations. Small oscillating motors embedded in the garment and peripherals produce a vibrating touch sensation when activated. Each motor has a logic address on the suit or peripheral device that correlates to a logical point on a computer graphic representing the user. Contact with the graphic will generate a command signal that activates a motor in the corresponding area on the suit. In one application, limb covers with embedded oscillating motors are used to provide medical treatment massage therapy.

### Review of Prior Art for Finger Activated Data Input

Finger activated data input devices offer alternative methods for entering data into a computer or other device. One such device is presented in U.S. Pat. No. 4,905,001 issued to Penner which discloses hand-held finger movement actuated communication devices and systems employing such devices. These devices serve as alternatives to a keyboard and allow the user to receive communications via the sense of touch. Various forms of hand-held communication devices are disclosed and may be used by persons who are deaf and speechless, or blind, deaf and speechless. Eight switch elements may be operated by the four fingers of a person's hand in predetermined combinations suitable, for example, for communication in a binary code. Two distinct types of movement, pushing and sliding, are supported by each of the switch actuators and operate a pair of switch elements. In a third disclosed embodiment, collar-like rings are worn about the proximal and middle segments of the user's hand. Relative motion between the collar-like rings and a wrist harness is sensed in response to thrust and push motions of the fingers. Stimulation elements, such as vibrators, are provided and connected to corresponding switch actuators to facilitate two-way communication.

A second finger activated data input device is found in U.S. Pat. No. 7,012,593 issued to Yoon et al. which discloses a glove-type data input device and related sensing method. A change in glove shape is detected by sensors within the glove through a change in resistance or conductance. The analog output of the sensors communicates a predetermined sensing signal to an analyzer through wired or wireless means. The analyzer determines the data type sent from the data input device and translates the data into meaningful information for display on a terminal. Functions such as scrolling and clicking, traditionally performed with a mouse, and character inputs, as would be performed with a keyboard, are achieved with the glove-type data input device.

A third example of a finger activated data input device is presented in U.S. Pat. No. 6,141,643 issued to Harmon which discloses a data input glove having conductive finger pads and thumb pad. Various signal combinations are established by contacting a finger or thumb sensor with a sensor on the palm. A computer processor translates input from the data input glove into letters, numbers or symbols, and an output device, such as a visual display unit or speakers communicates the resulting data to another individual.

### Review of Prior Art for Tactile Stimulation in Notification Systems

Tactile stimulation is also utilized in electronic assistance and notification systems. One example may be found in US. Pat. No. US20130162398A1 issued to Stoick which discloses an electronic assistance call device system and method. The system consists of a transmitter portion, worn by a first person with a potential need for assistance, and a receiver portion worn by a second person who is monitoring the state of health of the first person. Both devices may be worn on a neck lanyard or on a wrist strap. Upon activation of the transmitter, a signal is sent from the transmitter directly to the receiver portion. The receiver portion, in turn, provides the second person with an alert via the receiver, which can be by a tactile vibration, a sound and a light, or any combination of such modalities to signal that assistance is required. The transmitter and receiver portions each utilize active RFID tags to send and received an alert message, with the alert message on the receiver end activating a warning through a tactile vibration, sound, light, or combination thereof.

While various means of tactile signaling are demonstrated in the previous review of the prior art, none meet all the requirements of the current invention which include silent, covert, multi-finger communication between two or more people. Additionally, the system must integrate into clothing or equipment used by the sport or other relevant activity without causing discomfort or impeding performance.

### BRIEF SUMMARY OF THE INVENTION

One or more aspects of the current disclosure provide a solution to the problem of intercepted or decoded hand signals or other non-verbal cues that are used to gain a competitive advantage in sports and other activities. A multi-user tactile communication system is provided. Users are outfitted with tactile communication transceivers embedded in an article of clothing or associated accessory. Coded messages are sent securely over a wireless network in a covert fashion by utilizing the fingers of the hand. A language only known to system users, with a character or specific command associated with specific fingers of the hand, is transmitted via pulse triggering devices with the fingers of the hand. Responses from other users are sensed by the fingers of the hand through tactile simulation induced by vibration producing devices.

In one or more aspects of the current disclosure, a solution to the issue of pitch sign stealing by the opposing team in Major League Baseball (MLB) is presented. Communication occurs between 2 or more users, player comfort and game performance is not impacted, changes to field infrastructure are not required, communication is covert, the speed of play is increased, and benefits to other aspects of the game are demonstrated. The gloves of the pitcher and catcher are outfitted with tactile communication transceivers. The pitcher, out of the sight of the batter and everyone on the opposing team, uses the fingers of the gloved hand to communicate the desired pitch type. A sequence of pulse triggering device selections are made by the pitcher and wirelessly communicated to the catcher. The corresponding vibration producing devices in the catcher's glove are activated and the desired pitch is communicated to the catcher. The gloves of position players may also be outfitted with tactile communication transceivers (in receive mode only) so they can make any necessary adjustments to field positioning based on a called pitch.

Another aspect of the present disclosure integrates a controller into the multi-user tactile communication system that is operated by a master user. The master user communicates strategy and tactics to users by interacting with various controller functions. In one example of this aspect, a baseball team manager directs an outfielder to move in (closer to the infield) by interacting with the controller screen to move an icon of the player on the screen. The player, outfitted with a tactile communication transceiver within their glove, receives direction to move in through the vibration producing devices embedded in their glove.

In another aspect of the present disclosure, offensive players (batters and baserunners) and coaches are outfitted with custom hand-worn or hand accessed accessories that are integrated with tactile communication transceivers. The configuration of these customized accessories can take several forms. One example presented utilizes a cuff type device worn in the coach's pocket with compartments that accept each finger. For the players (batters and baserunners), a patch type device that might be velcroed to the upper leg is presented. Since the batters and baserunners only need to receive directions (no need to transmit), the device does not require pulse triggering devices, resulting in a more compact form factor.

The team manager communicates tactics or changes in strategy to the base coaches by interacting with related controller functions. An example of this aspect involves the manager calling a “hit and run”, where the baserunner runs to second base once the pitch is thrown and the batter attempts to hit the ball. The manager communicates the play to the coach, again by interfacing with the controller. The base coach receives the message through vibrations in the corresponding vibration producing devices and immediately relays the message to the batter and baserunner via the pulse triggering devices. The batter and baserunner will simultaneously receive the same message via the vibration producing devices in their patch type devices and execute the hit-and-run play.

While the incorporation of this aspect of the present disclosure (offensive play) is not required to solve the issue of pitch sign stealing (defensive play), it does offer advantages not previously considered. These include the participation of the coach and manager in communicating signals from the bench, which is lacking in some of the prior art. Also, the element of surprise is added to the game by allowing communication of tactics and strategy modifications within seconds without the opponent's knowledge. Pace of play is increased resulting in shorter game times, a priority of MLB.

### BRIEF DESCRIPTION OF THE SEVERAL VIEWS OF THE DRAWING

FIG. 1 is a perspective view of a pitcher and catcher communicating a pitch type in accordance with one or more aspects of the current disclosure;

FIG. 2 is a block diagram showing interconnections between major electrical components of a tactile communication transceiver;

FIG. 3 is a cross-sectional view of a finger in a glove indicating its relative position to the corresponding pulse triggering device and vibration producing device of the tactile communication transceiver;

FIG. 4 is a perspective view of the gloves of a pitcher and catcher outfitted with transceivers and communicating over a secure wireless local area network;

FIG. 5 is a perspective view of a controller with representative screens shots that illustrate functionality and user communication over a secure wireless local area network;

FIG. 6 is a flowchart that illustrates an example of a communication sequence between the users of the system;

FIG. 7A is a perspective view of a cuff style tactile communication transceiver;

FIG. 7B is a sectional view of a finger interacting with components in a cuff compartment;

And

FIG. 8A is a perspective view of a patch style tactile communication transceiver (receive only); FIG. 8B is a sectional view of finger sensing output of vibration producing device.

### REFERENCE NUMERALS USED IN FIGURES

| | |
|---|---|
| 100 | pitcher |
| 101 | catcher |
| 102 | secure wireless local area network |
| 103 | batter |
| 200 | pulse triggering device |
| 201 | vibration producing device |
| 202 | flexible printed circuit board |
| 203 | battery |
| 204 | wiring |
| 300 | finger |
| 301 | baseball glove |
| 400 | transceiver installed in pitcher's glove |
| 401 | transceiver installed in catcher's glove |
| 500 | controller |
| 501 | manager |
| 502 | player and coach management interface |
| 503 | opposition data interface |
| 504 | system health monitoring interface |
| 505 | players and coaches on the field |
| 700 | cuff style tactile communication transceiver |
| 800 | patch style tactile communication transceiver |

### DETAILED DESCRIPTION OF THE INVENTION

The present disclosure provides a solution to the problem of intercepted or decoded hand signals or other non-verbal cues that are used to gain a competitive advantage in sports and other activities. It utilizes the fingers of the hand to send and receive covert messages through vibrotactile signaling over a secure wireless network in a silent and undetectable manner. The technique of using technology to stimulate the user's sense of touch to communicate a message is referred to as haptics. Electromagnetic technology in the form of vibratory motors with an offset mass, such as that found in most cell phones, is utilized.

In a first embodiment, a device, system and method are presented as a solution for the issue of pitch sign stealing in Major League Baseball (MLB). The traditional ‘baseball language” of pitch types as communicated through the fingers of the hand by the catcher to the pitcher is maintained, but in a silent and covert manner. Additional users such as positional players, coaches, and the manager may be added to the secure wireless local area network, thereby expanding the benefit of covert communication to other aspects of the game. This first embodiment is described hereinbelow with reference to the accompanying drawings.

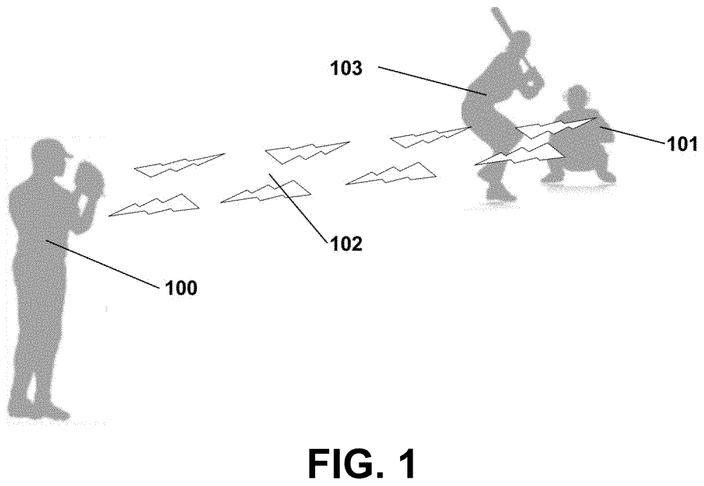

Referring to FIG. 1, a system in accordance with the present disclosure is illustrated. It is a perspective view of two users of the system, pitcher 100 and catcher 101 covertly communicating a pitch type via vibrotactile signaling with the fingers of the hand over a secure wireless local area network 102 while batter 103 awaits the pitch.

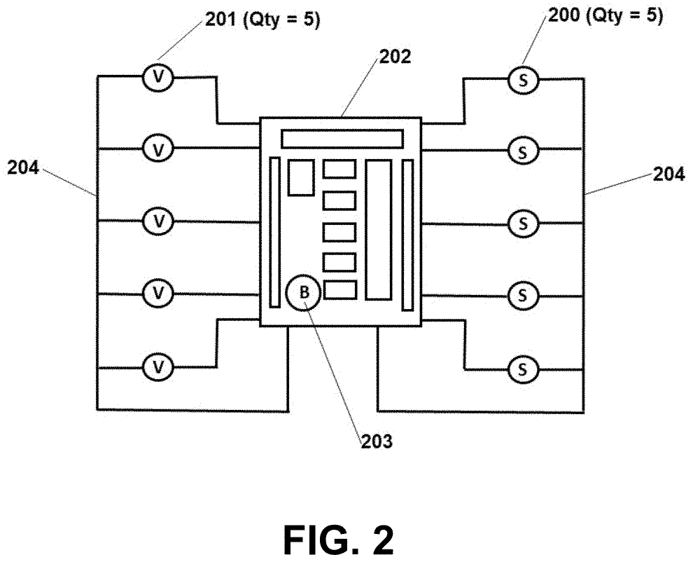

FIG. 2 is a block diagram of the components that make up the tactile communication transceiver, which is housed within the glove of each player on secure wireless local area network 102. Each glove and corresponding tactile communication transceiver is a node with transmit and/or receive capabilities on secure wireless local area network 102. Additional embodiments of a node, discussed below, may be in the form of a cuff or patch type “housing” (vs. that of a glove) and as with the glove, outfitted with a tactile communication transceiver (FIG. 2).

The tactile communication transceiver (FIG. 2) is comprised of a flexible printed circuit board 202, battery 203, and wiring 204 that connects pulse triggering devices 202 and vibration producing devices 201 to flexible printed circuit board 202. Flexible printed circuit board 202 includes a microcontroller, memory, embedded software, power conditioning, wireless communication module, and analog & digital I/O. Battery 203 is shown mounted to flexible printed circuit board 202 but may be mounted remote to flexible printed circuit board 202 to reduce stress on the board. Both a primary (disposable) or secondary (rechargeable) battery type of the appropriate chemistry may be utilized. Easy access to battery 203 for changeout or charging is required. The method or arrangement of the components and wiring or connecting of the electronic components is well known to those with ordinary skill in the electronic or mechanical arts.

Each node, whether in the form of a baseball glove, as presented in this first embodiment, or in the alternative forms worn on the body and discussed below in other aspects of this first disclosure, all contain the same set of components that comprise the tactile communication transceiver (FIG. 2). In addition, the inner construction of the node is such that it positions each finger adjacent to a designated pulse triggering device and designated vibration producing device (like a glove with compartments for each finger). Adding or removing nodes to or from secure wireless local area network 102, updating software, monitoring system performance and battery life, etc., is accomplished by a personal computer or laptop on secure wireless network 102.

The protocol for secure wireless local area network 102 can include but is not limited to Bluetooth™, infrared, radio transmission including computer digital signal broadcasting and reception commonly referred to as Wi-Fi or 802.11. X (where x denotes the type of transmission), satellite transmission, or any other type of communication protocol or system currently existing or to be developed for wirelessly transmitting data. To protect the integrity of the wireless data, the system will use conventional code encryption algorithms currently in use or that may be in use in the future.

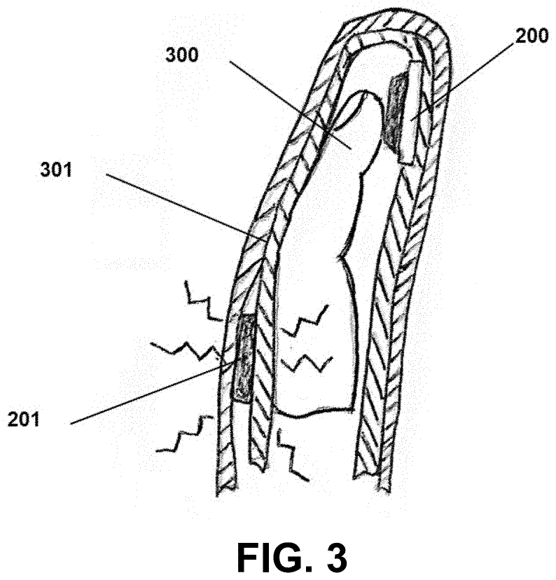

FIG. 3 is a cross-sectional view of a finger 300 in a baseball glove 301 to illustrate its position relative to a pulse triggering device 200 and vibration producing device 201 of the tactile communication transceiver (see FIG. 2). A pulse triggering device 200 is located just below the tip of each finger 300, while a vibration producing device 201 is located on the opposite side of the finger 300, embedded in the baseball glove 301 just below the knuckle. Each finger 300 of baseball glove 301 (index, middle, ring, pinky, and thumb) is configured in the same way. Covert signals are sent with pulse triggering device 200 and received by vibration producing device 201.

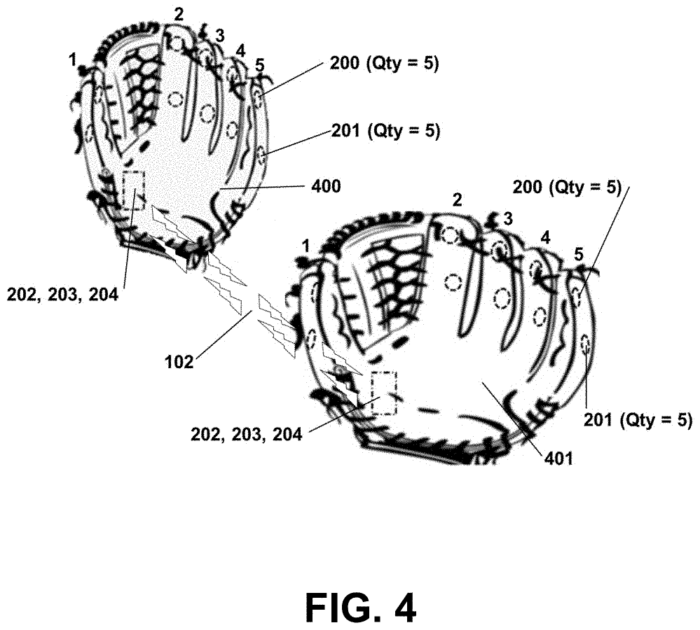

FIG. 4 is a perspective view of a pitcher's glove 400 and catcher's glove 401, both with tactile communication transceivers (FIG. 2) installed. The location of the five pulse triggering devices 200 and five vibration producing devices 201 is shown within the finger compartments of each glove (400 and 401). In addition, the location of flexible printed circuit board 202, battery 203, and wiring 204 is illustrated. While not explicitly shown, wiring 204 is routed between flexible printed circuit board 202 and pulse triggering devices 200 and vibration producing devices 201.

The fingers (not shown in FIG. 4) are numbered 1 to 5 for pitch coding purposes (number assignments are configurable by the user). Both pitcher's glove 400 and catcher's glove 401, along with the gloves of any other players on secure wireless local area network 102, are configured in the same manner. As explained below, “communication rights” (send/receive or just receive) will be established based on a player or coach's position or role.

Pressing pulse triggering devices 200 on one glove will activate corresponding vibration producing devices 201 of the same finger on the other glove or gloves communicating over the secure wireless local area network 102. As an example, catcher 101 presses pulse triggering devices 200 adjacent to index finger (#2) and middle finger (#3) in succession to indicate a fastball to pitcher 100 who will receive a “buzz” from vibration producing devices 201 on the corresponding fingers. In the same manner, activation of any sequence of pulse triggering devices 200 by pitcher 100 (whether to accept or suggest another pitch type) will be sensed by catcher 101 on corresponding vibration producing devices 201.

In this first embodiment, pulse triggering device 200 is a momentary switch, meaning that the duration of the signal (or time that vibration producing device 201 is energized) is dependent on the length of time it is pressed by the finger. Selection of the appropriate momentary switch type is a balance between durability and user comfort.

Vibration producing device 201, referred to in industry as a vibration motor, may or may not be in direct contact with the skin of the finger. It may be advantageous in terms of player comfort to isolate vibration producing device 201 within the inner layer of cowhide (or other liner) of the glove. Again, this is a balance between player comfort and sensitivity to the vibration. The vibration frequency of vibration producing device 201 may be adjusted to increase or decrease sensitivity.

Flexible printed circuit board 202 and battery 203 are embedded within the glove and located in the area between the index finger and thumb on the top side. This area is the least susceptible to damaging shock and stress. Flexible printed circuit board 202 is designed such that sensitive components are isolated from any bending or bearing stress. Other areas for locating flexible printed circuit board 202 may be considered if necessary, to limit stresses on the board. Vibration producing devices 201, by virtue of their location on the back side of the glove, are less susceptible to these forces. Wiring 204 consists of signal and power wires and is routed between flexible printed circuit board 202 and pulse triggering devices 200 and vibration producing devices 201. Wiring 204 is routed within the glove in a manner (preferably on the top areas of the inner glove) to minimize exposure to stress and shock.

Up to this point in the presentation of the first embodiment, the focus has been on two player, or pitcher 100 to catcher 101 communications. As mentioned, additional players can join the network once they have a glove outfitted with a tactile communication transceiver (FIG. 2). Position players, in particular infielders, are at a disadvantage unless they can anticipate the type of pitch thrown by the pitcher. As the game is played today, they observe the sign flashed by the catcher and change defensive positioning in anticipation of where the batter might hit a ball based on the pitch type. Adding a player to the secure wireless local area network is as simple as providing them with a glove outfitted with a tactile communication transceiver (FIG. 2) and configuring access via a personal computer, laptop, or other computer device. Note that position players only need to know the pitch type decided by the pitcher and catcher (one-way communications). Their gloves will either have the pulse triggering device 200 disabled or omitted.

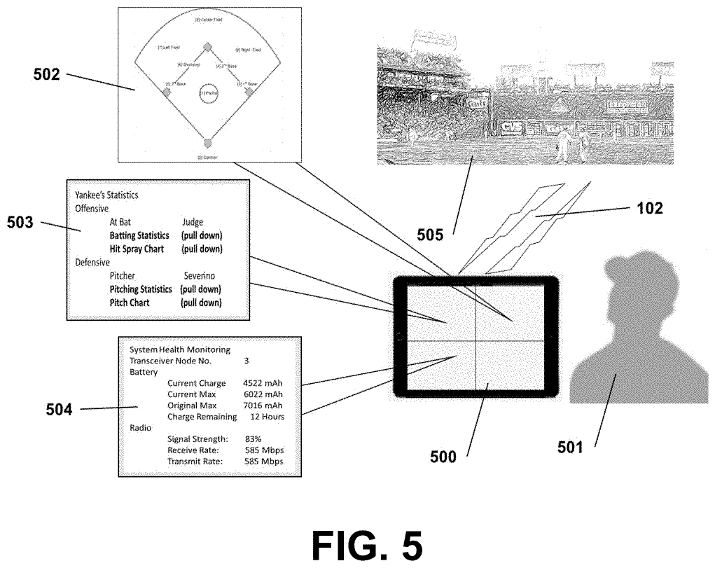

With the incorporation of controller 500 shown in FIG. 5, the benefits of the present disclosure to the game of baseball can be extended even further. FIG. 5 shows a master user in the form of manager 501 positioned in the dugout and communicating wirelessly to players and coaches on the field 505 by interfacing with controller 500 (for this first embodiment, these communications only include those on the defensive side of the game). These managerial actions include signaling a change in pitching strategy (e.g. having the pitcher keep the pitch low and outside), or repositioning outfielders (e.g. move in or out). As the game is played today, changes in pitching strategy are communicated by the manager or coach by visiting the pitcher on the field or signaling position players with hand or arm movement from the dugout (sometimes not getting their attention in a timely manner). Communicating by these traditional means increases the risk of the opposition deciphering strategy or tactics and increases game delays.

FIG. 5 shows three representative controller 500 screen shots available to the master user or manager 501 to keep the opposition guessing and improve the speed and efficiency of the game (any number of interfaces and controls can be incorporated by the team). The screen shot of player and coach management interface 502 displays on the screen each player that is outfitted with a tactile communication transceiver node (the coach management function comes into play in an additional embodiment presented below). Moving the player icon on the screen (in or out, or left or right) will activate a corresponding pulse triggering device 200 in the player's glove.

As an example, a buzz on the thumb might indicate move right, buzz on the pinky indicates move left, buzz on the middle finger indicates “move in”, and a buzz on the index finger indicates move out. Individual finger buzzes might be replaced with a specific number of buzzes on a finger (say one to four buzzes) to indicate in or out or left or right movement. Communicating a change in pitch strategy to the pitcher and catcher is performed by highlighting their icons and initiating the change. This could entail choosing from a list in a separate screen pull-down box that is part of the screen shot of player and coach management interface 502. Note that the ultimate configuration of the interactive screen commands, and signal and pitch sign designations, is user defined. The presented scenarios are for the purpose of illustration only.

Statistics showing the opposing team's offensive tendencies (e.g. how well they hit or run the bases in certain situations) is available to the manager 501 and illustrated in the screen shot of opposition data interface 503. With the immediate availability of this kind of data, little time is wasted in making changes to the player's defensive positioning.

The screen shot of system health monitoring interface 504 captures the health status of all transceiver nodes (FIG. 2) in operation on the field. Items such as battery charge state, wireless signal strength, and system performance are listed. Impending performance issues, such as a battery running low on charge, can be dealt with (by changing out the battery 203 between innings) prior to a failure and ultimate disruption of play. The configuration of the controller interfaces, extent of the data displayed, and the type of covert communication wirelessly communicated between the master user (in this case the manager 501) and the users (players) is user defined.

### Operation

Prior to the start of the game, the proper state of battery 203 charge and the connectivity of all transceiver nodes on secure wireless local area network 102 is verified. This action can be achieved by a PC on the network or with controller 500 detailed in FIG. 5.

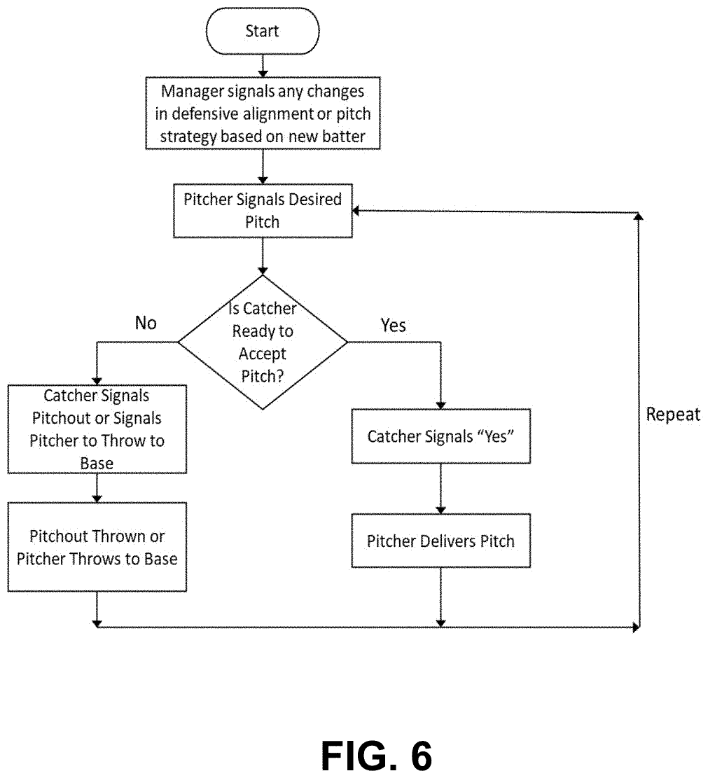

FIG. 6 is a flowchart that illustrates a possible order of events between the time the opposing batter starts walking to the plate and the completion of the opposing player's at-bat. The events shown are for illustrative purposes only since the system is customizable depending on the tactics and sign signals of a given team. Prior to reviewing the steps in FIG. 6, a discussion of possible pitch types and cues used in the game and how they could be communicated with this system is in order. Table 1 shows a partial list of pitch types with locations and cues that could be communicated between the pitcher and catcher.

TABLE 1
Partial List of Possible Pitch Types with Corresponding
Pulse triggering device 200 Sequence

| | Finger Number | | | | |
|---|---|---|---|---|---|
| Pitch Type or Cue | 1 | 2 | 3 | 4 | 5 |
| Fastball Outside | | A | | | B |
| Fastball Inside | B | A | | | |
| Curveball Outside | | A | B | | C |
| Curveball Inside | C | A | B | | |
| Slider Outside | | A | B | C | D |
| Slider Inside | D | A | B | C | |
| Changeup Outside | E | A | B | C | D |
| Changeup Inside | | A | B | C | D, E |
| Catcher Signals “Yes” | | A, B, C | | | |
| Pitchout | | | A, B | | |
| Throw to First Base | A, B | | | | |

Note:
For a given pitch type, the order of tactile switch 12 selections is alphabetic (i.e. A is first, B is second, etc.)

For each pitch type, the sequence of pulse triggering device 200 selections corresponding to the finger number is shown. Using a curveball outside as an example, the catcher selects pulse triggering devices 200 in the following sequence: 2, 3, and 5. Note that if a player is missing one or more fingers, the sequences can be modified based on the available fingers. Also, additional details can be added to a pitch type (e.g. fastball outside and high in the strike zone). The extent of signs or cues is only limited by the imagination of the team.

The pitch selection scenario detailed in FIG. 6 assumes that the connection between the pitcher and catcher over the secure wireless local area network 102 stays open throughout the game. It may be beneficial to close the network between innings to avoid distracting signals (“buzzes” in the glove). This is a user defined setting.

The system operation is described below and follows the sequence of steps outlined in FIG. 6. Note that the reference numbers for pitcher 100, catcher 101, batter 103, and manager 501 have been omitted for the sake of clarity.
1. The batter starts walking to the plate. The manager relays any defensive alignment changes or changes in pitch strategy through the player and coach management interface 502 of the controller 500. Note that if a controller 500 is not being used, any player adjustments are performed through traditional means.
2. As the batter gets into position at the plate and awaits the pitch (FIG. 1), the pitcher, outfitted with a transceiver node installed in glove 400, uses the fingers 200 of the gloved hand (FIG. 3) to communicate the desired pitch type out of sight of the opposing team. A sequence of pulse triggering device 200 selections (see Table 1 for example pitches) are made by the pitcher. The signal is conducted through wiring 204 and received as inputs by flexible printed circuit board 202 in the pitcher's glove 400. The software embedded in the microcontroller of flexible printed circuit board 202 instructs the onboard wireless communication module to open communications with the same set of hardware and software installed in catcher's glove 401 via the secure wireless local area network 102. The software embedded in the microcontroller of flexible printed circuit board 202 in catcher's glove 401 processes the signal from the pitcher and activates the corresponding vibration producing devices 201 in catcher's glove 401 in the same sequence sent by the pitcher.
3. If the catcher sees no potential threat of stealing by the opposing team's baserunner(s), a “yes” is signaled back to pitcher. The communication of this signal is processed and transmitted to the pitcher as described in the previous step. The pitcher then delivers the pitch to the batter. The cycle repeats.
4. If the catcher decides there is a baserunning threat that requires the pitcher's attention, a signal for the threat (such as the need for a pitchout or that the runner on first has a big lead and could be picked off) is sent to the pitcher who responds accordingly (throws pitchout to the catcher or throws to first base to pickoff the runner).
5. Once either of these scenarios plays out, the process is repeated.

### Additional Embodiments

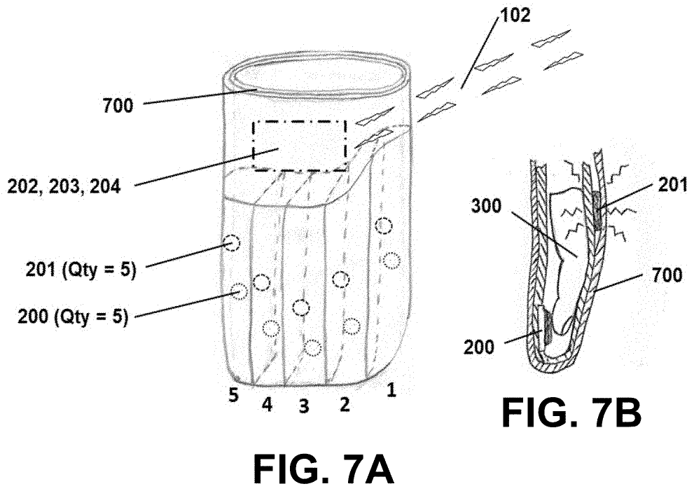

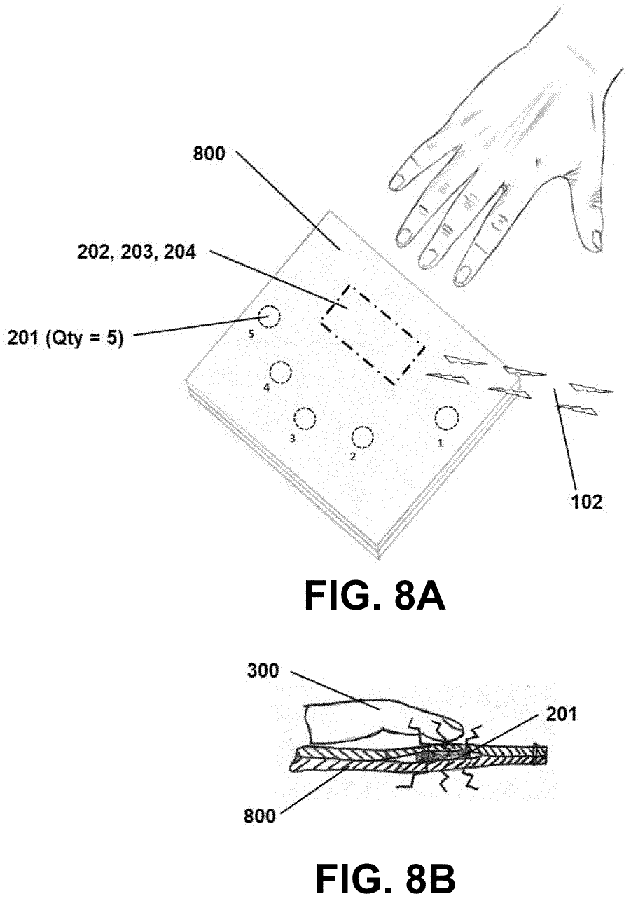

The first embodiment presented above focuses on the defensive side of the game, offering a solution to the issue of pitch sign stealing, and expanding the system's benefits to other parts of the game with the incorporation of controller 500. By incorporating two additional styles of tactile communication transceivers (FIGS. 7A, 7B, 8A, and 8B), the disclosed covert tactile communication system can be utilized to improve play on the offensive side of the game, specifically the performance of batters and baserunners.

The line of strategic or tactical communication of a team “at bat” (offensive play) is between the manager and the base coaches (first and third base), who then in turn communicate to the batter and baserunners. An example is the situation with a baserunner on first base and a batter at the plate. The manager may decide to call a “hit and run”, where the baserunner runs to the next base once the pitch is thrown and the batter swings at the ball (no matter how good a pitch it is). To initiate this call, the manager will make a traditional hand to body gestures known only to the team (e.g. touch face and tap arm twice) to a base coach who will signal the runner in the same way. While the stealing of these types of signs is not as critical to winning or losing as the stealing of pitch signs, opposing teams may get a clue from previous actions what's coming or will just be aware that “something is going to happen”. As pointed out in the review of the prior art that address the issue of pitch sign stealing, none of the prior art provided an option for the manager and coaches to send covert signals.

Two new types of tactile communication transceivers are required for this offensive improvement to the game of baseball to be realized. The first type, shown in perspective view in FIG. 7A, is a cuff style tactile communication transceiver 700 node, worn in a pocket, on the surface of or inside the uniform (permanently attached or velcroed in place). It is made of multiple layers of any type of flexible material such as cloth or plastic (acceptable by the user) and sewn together to form the finger pockets and house the components.

A flexible printed circuit board 202 and battery 203 is installed on the inner top surface of cuff style tactile communication transceiver 700, housed between two layers of material, with the signal and power lines of wiring 204 running between flexible printed circuit board 202 and pulse triggering devices 200 and vibration producing devices 201. FIG. 7B shows a cross section of a finger compartment (one for each finger like a baseball glove) of the cuff style tactile communication transceiver 700 with a finger 300 located relative to a pulse triggering device 200 and vibration producing device 201. The cuff style tactile communication transceiver 700 functions in the same manner as the pitcher and catcher gloves (400 and 401) of FIG. 4, communicating to other nodes over the secure wireless local area network 102. The only difference being that the baseball glove is replaced by cuff style tactile communication transceiver 700.

FIG. 8A is a perspective view of a patch type tactile communication transceiver 800 node that is limited to one-way communication (no pulse triggering devices 200). Like the cuff style node, it is made of any type of flexible material such as cloth or plastic (acceptable by the user), but is of a simpler construction, with a minimum of two layers sewn together to encase the components. The user's hand is placed on patch style communication transceiver 800 to receive tactile signals from the embedded vibration producing devices 201. It may be worn in a pocket, on the surface of, or inside the uniform (permanently attached or velcroed in place). It consists of patch style tactile communication transceiver 800 integrated with vibration producing devices 201, flexible printed circuit board 202, battery 203, and wiring 204, and communicates to the other nodes over the secure wireless local area network 102. FIG. 8B is a cross-section of a finger of a hand resting on the top surface of patch style tactile communication transceiver 800, sensing the tactile signal from vibration producing device 201.

The cuff style tactile communication transceiver 700 (FIG. 7A) is best utilized by the base coaches who require 2-way communication capability. The coaches receive instructions from the manager 501 via the controller 500, and then relay the instructions to the batter or baserunners. As with pitcher to catcher communications, signals are received on the coach's vibration producing devices 201 from the manager, then immediately transmitted to the batter or baserunner(s) via pulse triggering devices 200. Although a glove style transceiver node is more appropriate for a fielder (since they are outfitted with gloves), it could be replaced by a cuff style node. A catcher could utilize a cuff node, positioning it underneath the chest protector and inserting the hand when communicating with the pitcher.

The patch style tactile communication transceiver 800 (FIG. 8A) is configured for batter and baserunner use as they are only required to sense signals (no response required). Signals are received from a coach on vibration producing devices 201. A player readying for an at-bat will velcro the patch style tactile communication transceiver 800 inside a pocket or to a convenient area of the uniform that accommodates receiving signals while batting and baserunning. The patch style tactile communication transceiver (FIG. 8A) is removed once the player scores or leaves the field. While it could be a permanent part of the player's uniform, it may be more advantageous to be removable, as described, in terms of player comfort.

While at bat or on base awaiting a signal from a base coach, the player places their hand on patch style communication transceiver 800, with each finger covering a pulse triggering device 200 embedded within the patch. A buzz or series of buzzes from pulse triggering devices 200 will indicate an action such as hit-away for a batter or steal second for a baserunner. Note that communicated actions from the base coaches that involve multiple players (such as a hit-and-run) will be communicated to all players involved.

It is conceivable that locating patch style tactile communication transceiver 800 on the front part of the upper leg will best accommodate both batting and running. Under this scenario, a batter, prior to stepping to the plate, rests a free hand on the patch 800 and receives instructions from the coach via vibration producing devices 201. While on base and in a stance required to get a good running start, the baserunner can easily place a hand on the patch 800 while in position to run and receives instruction from the coach in the same way.

The player and coach management interface 502 of controller 500 (FIG. 5) is utilized by the master user or manager 501 to communicate offensive tactics to the base coaches in a similar fashion to defensive communications, albeit with a different pull-down menu or screen display. The team may decide to have the manager 501 communicate directly to the players and can configure the controller 500 software accordingly.

### CONCLUSIONS, RAMIFICATIONS, AND SCOPE

Accordingly, the reader will see that some or all of the features presented above in the first embodiment and additional embodiment will reduce the issue of pitch sign stealing in Major League Baseball (MLB) and improve the speed of play. These features include covert two-way sign calling, the ability to communicate last second defensive changes without providing visible or audible clues to the opposition, position players have knowledge of the selected pitch type, coaches and the manager can communicate instructions without providing visible or audible clues to the opposition, and no changes to field or stadium infrastructure is necessary. Additionally, the system integrates into clothing or associated game equipment without causing discomfort or impeding performance. The value of the present disclosure also extends to the offensive side of the game, with the ability to covertly communicate strategy and tactics to batters and baserunners.

While the above description contains many specificities, these should not be construed as limitations on the scope, but rather as an exemplification of one (or several) embodiment(s) thereof. Many other variations are possible. For example:
a) A force-sensing resistor could replace pulse triggering devices 200. This could serve 2 purposes: provide a lower profile (smaller, less invasive) means of sending a pitch signal and offer a means to vary the intensity of the signal. The force-sensing resistor outputs a voltage signal that varies with the level of fingertip force applied. A varying voltage signal allows one to control the intensity of the vibration producing device 201 (in addition to turning it on when depressed and off when released as with the pulse triggering devices 200), adding another dimension to the level of communications. A variable vibration could be used to communicate the urgency of a situation (runner stealing second) or to take something off a pitch (low amplitude buzz) or throw it hard (high amplitude buzz).
b) The vibrator elements of the vibration producing devices 201 may take many forms such as but not limited to electroactive polymer elements, piezoelectric elements, electrostatic surface actuation elements, etc. Alternative means to the vibration producing devices 201 specified in the first embodiment may afford the user more comfort, particularly when used in the form of a cuff or patch (FIGS. 7A, 7B, 8A, and 8B) because of their location on the body.
c) A single device, combining a plunger type switch and a coil/magnet arrangement that vibrates the plunger when energized, could replace the pulse triggering device 200 and vibration producing device 201.
d) While the focus of the first embodiment is on MLB play, all levels of baseball including collegiate, amateurs, minor leagues, and foreign baseball are candidates for this invention.
e) It should be noted that the cuff and patch configurations of FIGS. 7A and 7B and FIGS. 8A and 8B are two of many methods for “housing” a tactile communication transceiver (FIG. 2), which can include but is not limited to player equipment, such as batting gloves, guards or helmets, or other parts of the uniform not previously mentioned.
f) While baseball uses a “language” communicated through the fingers, there are several other applications that could benefit from the use of the covert language capabilities offered by the current disclosure including but not limited to:
   i. Interactive group sports such as paintball where teams use covert actions to dominate the opponent. Members of the same team could utilize a “language” that might change tactics on the fly (e.g. ambush group in far left corner of the building) or warn of an imminent attack.
   ii. Close quarter military operations where visual and verbal communications are not possible without disclosing presence to the enemy.
   iii. Police actions within buildings where several officers are approaching a dangerous suspect from different directions.
   iv. Videogaming where team players in remote locations currently uses text or voice to communicate. Each player could be outfitted with a tactile communication transceiver to communicate quickly and in a covert manner while minimizing distraction from the game.

Thus, the scope of the embodiments should be determined by the appended claims and their legal equivalents, rather than by the examples given.

I claim:

1. A multiple user tactile communication system comprising:
a) a plurality of tactile communication transceivers, each embedded within an article of clothing of said user, for sending and/or receiving coded messages between other said users on said tactile communication system via the fingers of the hand;
b) a plurality of pulse triggering devices within said tactile communication transceiver which are activated by a said finger for the purpose of transmitting said coded message to said users on said tactile communication system;
c) a plurality of vibration producing devices within said tactile communication transceiver which are located adjacent to said fingers and impart a vibratory stimulation in response to said coded message from said users on said tactile communication system.

2. A language only known to said users of said tactile communication system in claim 1 is communicated by said fingers, whereby each said finger represents a specific symbol of said language.

3. Said tactile communication transceivers of claim 1 are embedded in said article of clothing that may take the form of a glove, custom article, or sport or activity-related article worn by said user, and by virtue of its design will position each said finger adjacent to a designated said pulse triggering device and designated said vibration producing device.

4. Said users of said communication system of claim 1 send messages by activating said pulse triggering devices with said fingers and sense the receipt of messages from other said users via said vibration producing devices positioned against said fingers.

5. Said users of said tactile communication system as claimed in claim 1 communicate over a secure wireless network.

6. A tactile communication transceiver integrated into an article of clothing for sending and/or receiving coded messages between users on a tactile communication system via the fingers of the hand comprising:
a) a plurality of pulse triggering devices within said tactile communication transceiver which are activated by a said finger for the purpose of transmitting said coded message to said users on said tactile communication system;
b) a plurality of vibration producing devices within said tactile communication transceiver which are located adjacent to said fingers and impart a vibratory stimulation in response to a said coded message from said users on said tactile communication system.

7. Said tactile communication transceiver of claim 6 is embedded in said article of clothing that may take the form of a glove, custom article, or sport or activity related article worn by said user, and by virtue of its design will position each said finger adjacent to a designated said pulse triggering device and designated said vibration producing device.

8. Said tactile communication transceiver as claimed in claim 6 communicates over a secure wireless network.

9. A multiple user tactile communication system comprising:
a) a plurality of tactile communication transceivers, each embedded within an article of clothing of said user, for sending and/or receiving coded messages between other said users on said tactile communication system via the fingers of the hand;
b) a plurality of pulse triggering devices within said tactile communication transceiver which are activated by a said finger for the purpose of transmitting said coded message to said users on said tactile communication system;
c) a plurality of vibration producing devices within said tactile communication transceiver which are located adjacent to said fingers and impart a vibratory stimulation in response to said coded from said users on said tactile communication system;
d) a controller for said multiple user tactile communication system in the form of a computer or smart phone with user interface.

10. A language only known to said users of said tactile communication system in claim 9 is communicated by said fingers, whereby each said finger represents a specific symbol of said language.

11. Said tactile communication transceivers of claim 9 are embedded in said article of clothing that may take the form of a glove, custom article, or sport or activity related article worn by said user, and by virtue of its design will position each said finger adjacent to a designated said pulse triggering device and designated said vibration producing device.

12. Said users of said communication system of claim 9 send messages by activating said pulse triggering devices with said fingers and sense the receipt of messages from other said users via said vibration producing devices positioned against said fingers.

13. Said users of said tactile communication system as claimed in claim 9 communicate over a secure wireless network.

14. Said controller of claim 9 is operated by a master user who establishes communication capabilities of said users, whether 2-way communication or sense mode only, and said master user can choose to communicate to all or a select group of said users.
